(19) United States
(12) Patent Application Publication
(10) Pub. No.: US 2006/0164146 A1
(43) Pub. Date: Jul. 27, 2006

(54) Edge shifted pulse train generator

(76) Inventor: Hisao Takahashi, Kanagawa (JP)

Correspondence Address: WILLIAM K. BUCHER;TEKTRONIX, INC., P O BOX 500 (50-LAW), BEAVERTON, OR, 97077-0001, US

(21) Appl. No.: 11/326,161

(22) Filed: Jan. 4, 2006

(30) Foreign Application Priority Data
Jan. 21, 2005 (JP) 2005-14140

(51) Int. Cl. G06F 1/04

(52) U.S. Cl. 327/291

(57) ABSTRACT

A pulse train generating circuit has a pattern generating circuit 10 that includes a memory 9 to store pattern data and reference voltage data, and synchronously provides the pattern data and the reference voltage data from the respective terminals A and B. A digital to analog converter 14 converts the reference voltage data into a reference voltage signal. A LPF 12 slopes the pulse edges of the pattern data. A comparator 16 compares the reference voltage and the output of the LFP 12 to produce a pulse train of which edge positions are changed. The resulting jittered pulse train is derived from a reference pulse train.

### BACKGROUND OF THE INVENTION

The present invention relates generally to pulse generators and more particularly to a pulse train generator that can shift each edge position of a reference pulse train by a desired amount in real time.

In a circuit design process, a prototype circuit is made but needs to be tested to meet the desired specifications. A signal generator is used to provide an input signal to the prototype circuit.

A digital circuit processes a pulse train pattern or pattern data in many cases. The circuit may not receive an ideal pulse train pattern in which case some of the rising and/or falling edges shift from the ideal position. This results in jitter being present on the rising or falling edges. A jitter tolerance test is performed on the digital circuit to determine the level of jitter tolerance of the circuit.

A pulse train including jitter may be provided to the circuit under development to confirm whether the circuit has an expected jitter tolerance. Therefore, a pulse train generator has been developed that it provides a pulse train in which rising and/or falling edges are shifted by desired amounts according to user setting relative to those of an ideal pulse train or reference pulse train.

U.S. Pat. No. 5,389,828 discloses an example of changing pulse widths by shifting rising or falling edges of an input pulse train. Referring to FIG. 1, a comparator 4 compares an input pulse train with an output voltage of a digital to analog converter (DAC) 2 to shift one of the rising and falling edges of the input pulse train. A delay line 6 delays the input pulse and a logical OR circuit 8 shifts the other of the rising and falling edges. That is, the change of delay by the delay line 6 changes the width of the pulse.

The circuit described in U.S. Pat. No. 5,389,828 changes the pulse width by changing the delay of the delay line 6. There are variuos types of delay lines but, at the present, none of them have a sufficiently short setting time to change the delay time of the delay line for changing each pulse width of a GHz pulse train in real-time.

US patent publication No. 2004/0135606 discloses an invention to overcome the long setting time of delay data. The circuit has two delay blocks in which one block receives an input pulse train and varies the rising and/or falling edges of the input pulse train while the other block changes the delay time setting. Then the other block receives the iinput pulse train and varies the rising and/or falling edges while the first block changes delay time settings. However, this circuit adds jitter to the pulse train that is asynchronous to the system clock of the circuit so that it requires detecting an edge position and, following the detection, switching from one to the other block. This operation impedes fast processing of changing edge positions of a pulse in real-time.

### SUMMARY OF THE INVENTION

Accordingly, a pulse train generating circuit generates a jittered pulse train that is produced by changing positions of rising edge and/or falling edge of a reference pulse train. A pattern generating means has a memory means for storing reference voltage data and pattern data, and produces the reference pulse train from the pattern data and provides the reference pulse train synchronized with the reference voltage data. A digital to analog converter converts the reference voltage data into a reference voltage. An edge sloping means that may take the form of a low pass filter slopes the edges of the reference pulse train. A comparator compares the reference voltage and the output of the edge sloping means, and produces a pulse train in which positions of rising and/or falling edges are changed relative to those of the reference pulse train.

The present invention produces a pulse train in which rising and/or falling edge positions of each pulse are changed to desired ones relative to a reference pulse train. The present invention can provides the pulse train while it changes the reference voltage data in a memory so that it can generate the pulse train with changing rising and/or falling edge positions in real-time.

The objects, advantages and other novel features of the present invention are apparent from the following detailed description when read in conjunction with the appended claims and attached drawings.

### BRIEF DESCRIPTION OF THE DRAWINGS

FIG. 1 is a block diagram of a conventional pulse width variable circuit.

FIG. 2 is a block diagram of a pulse train generating circuit according to the present invention.

FIG. 3 is waveform chart of the pulse train generating circuit shown in FIG. 2.

FIG. 4 is a block diagram of another example according to the present invention.

FIG. 5 is a block diagram of other example according to the present invention.

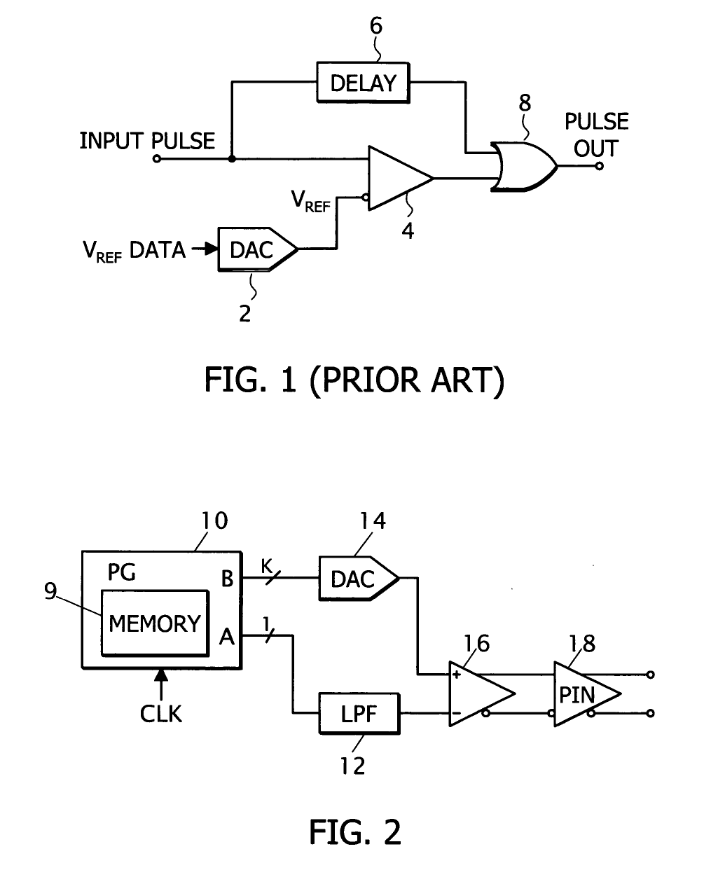

### DETAILED DESCRIPTION OF THE PREFERRED EMBODIMENT

Referring to FIG. 2, there is shown a block diagram of the pulse train generating circuit in a first embodiment of the present invention. The pulse train generating circuit is incorporated into a signal generator instrument, such as an arbitrary waveform generator or the like, that includes a microprocessor, RAM memory, hard disk drive (HDD), keyboard, and the like, which are not shown. The signal generator instrument operates under program control including the pulse train generating curicut of the present invention using programs stored in the RAM memory or on the hard disk drive. In the following descriptions, corresponding blocks in different Figs. are indicated by the same numbers.

A pattern generator 10 provides reference voltage data of K bits (K is a natural number) from the output B to a digital to analog converter (DAC) 14 according to a clock CLK. The pattern generator 10 also provides pattern data of one bit from the output A to a low pass filter (LPF) 12 according to a clock CLK. A memory 9 in the pattern generator 10 stores the reference voltage data and the pattern data according to user settings. A phase relationship between the outputs A and B may be adjustable. Typically, the pattern data from the output A lags the reference voltage data from the output B for a given time. The DAC 14 converts the reference voltage data into a reference voltage signal. The LPF 12 attenuates the high frequency component of the one bit pattern data so that the rising and falling edges are sloped. The reference voltage data and the pattern data may be a set of parallel data that is stored at the same address of the memory 9 for the simplicity. For example, the reference voltage data and the pattern data may be ten bit parallel data with nine bits designated for the reference voltage data and one bit designated for the pattern data. As another example, the reference voltage data and the pattern data may be stored at different addresses. A comparator 16 compares the outputs from the LPF 12 and DAC 14 to provide a pulse train.

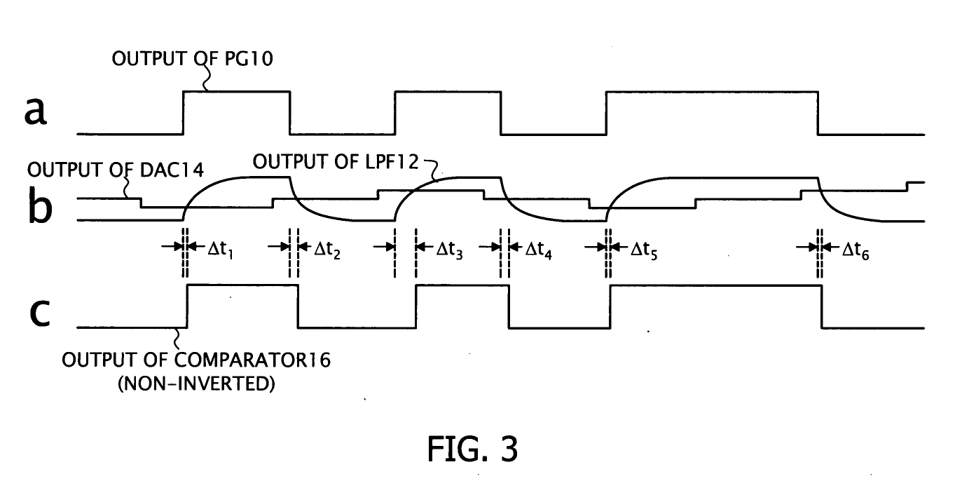

FIG. 3 shows a waveform chart for describing the pulse generator according to the present invention. FIG. 3a shows the reference pulse train from the output A. FIG. 3b shows the outputs from the DAC 14 and LPF 12. FIG. 3c shows an output from the comparator 16. The output pulse train of the comparator 16 shows delays tₙ at the rising or falling edges relative to the reference pulse train from the output A. In this example, the higher the voltage level of the LPF 12 output relative to the output of the DAC14, the more the rising edge delays, and the less the falling edge delays. A pin driver 18 makes the pulse train from the comparator have desired voltage.

Note that the pulse train generating circuit according to the present invention can independently control each delay amount of the rising and falling edges of each pulse because the reference voltage data and pattern data are synchronized. That is, the pulse train generating circuit can change the edge positions of each pulse of the refernce pulse train. The present invention may be used for inducing jitter to the output pulses of the reference pulse train. For example, the delay amount of the rising edge of each pulse may be change gradually according to a user desired function.

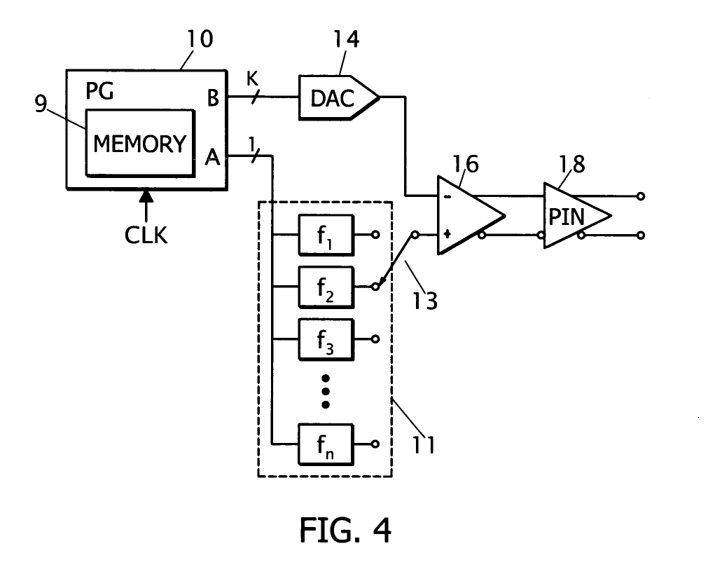

FIG. 4 shows a block diagram of another embodiment according to the present invention. The LPF 12 is replaced with a cutoff frequency variable filter 1 1 that can select one of the low pass filters of which cutoff frequencies are different. The filter 11 can provide various edge slopes of the pattern data and allows changing delay amounts of the edges by changing the selected LPF as well as the reference voltage change. That is, the pulse train generating circuit in this embodiment provides larger range of the delay amount than the pulse train generating circuit of FIG. 2. A switch 13 selects one of the plurality of the LPFs and may be a MEMS (Micro Electro Mechanical Systems) relay to provide fast switching and good impedance characteristics during switch off.

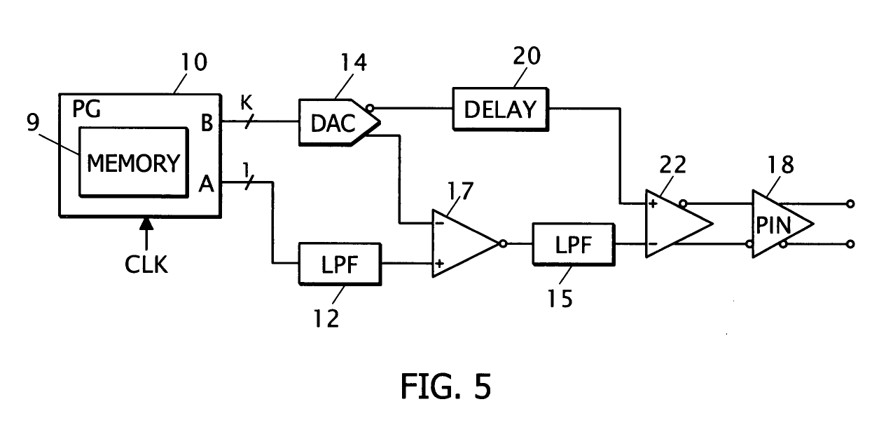

Referring to FIG. 5, there is shown a further embodiment of the pulse train generating circuit according to the present invention. The pulse train generating circuit in this embodiment provides twice the delay as that of FIG. 2 at the maximum. A delay line 20 delays an inverted reference voltage from the DAC 14 in accordance with the delay of a first comparator 17. The first comparator 17 provides an edge-delayed and inverted pulse train. A LPF 15 attenuates the high frequency components of the inverted pulse train from the first comparator 17 so that the rising and falling edges are sloped. A second comparator 22 compares the inverted reference voltage and the edge-delayed and inverted pulse train to delay each edge. As a result, it provides further delay to each edge relative to the reference pulse train. Additional similar stages may provide additional delays.

As described, the pulse train generating circuit of the present invention can independently control the delay of the each rising edge and/or each falling edge of a reference pulse train instead of by the plurality of pulses. Therefore, it pulse train generating circuit is suitable for generating a pulse train that includes jittered edges that is applicable to jitter tolerance testing of an electronic circuit. If pulse train generating circuit has sufficient memory capacity it could be rewriting the reference voltage data while it provides the reference pulse train so that it can provide the jittered pulse train substantially in real time.

What is claimed is:

1. A pulse train generating circuit comprising:
means for storing pattern data and reference voltage data;
means for synchronously providing a reference pulse train derived from the pattern data and the reference voltage data;
means for converting the reference voltage data into a reference voltage;
means for sloping the edges of the reference pulse train; and
means for comparing the reference voltage with the pulse train having the sloped edges to produce a pulse train of which edge positions are changed.

2. The pulse train generating circuit recited in claim 1 wherein the pattern data and the reference voltage data are a set of parallel data that is stored in memory means.

3. The pulse train generating circuit recited in claim 1 wherein the synchronous providing means may adjust the phase relationship between the reference pulse train and the reference voltage.

4. The pulse train generating circuit recited in claim 1 wherein the sloping means is a low pass filter.

5. The pulse train generating circuit recited in claim 4 wherein the low pass filter has a plurality of cutoff frequencies and one of them is selectively used.

6. The pulse train generating circuit recited in claim 1 further comprising:
a second sloping means receiving the output of the comparing means;
a second comparing means for comparing an output of the second sloping means with the reference voltage from the converting means.

7. A method for generating a pulse train comprising the steps of:
synchronously providing a reference pulse train and reference voltage data wherein the reference pulse train is derived from pattern data that is stored in memory means with the reference voltage data;
converting the reference voltage data into a reference voltage;
sloping the edges of the reference pulse train; and
comparing the reference voltage with the pulse train having the sloped edges to produce a pulse train of which edge positions are changed.

8. The method for generating a pulse train recited in claim 7 wherein the pattern data and the reference voltage data are stored as a set of parallel data in memory means.

9. The method for generating a pulse train recited in claim 7 wherein the phase relationship between the reference pulse train and the reference voltage may be adjusted.

10. The method for generating a pulse train recited in claim 7 wherein a low pass filter may slopes the edges of the reference pulse train.

11. The method for generating a pulse train recited in claim 10 wherein the low pass filter has a plurality of cutoff frequencies and one of them is selectively used.

12. The method for generating a pulse train recited in claim 7 further comprising the steps of:
sloping the edges of the produced pulse train; and
comparing the sloped edges of the produced pulse train with the reference voltage from the converting means to produce additional shifts of the edge positions of the produced pulse train.
